(19) United States
(12) Patent Application Publication
(10) Pub. No.: US 2013/0180986 A1
(43) Pub. Date: Jul. 18, 2013

(54) PRESSURE COOKER COVER

(71) Applicants: Zhigang He, Foshan (CN); Zhibin Huang, Foshan (CN)

(72) Inventors: Zhigang He, Foshan (CN); Zhibin Huang, Foshan (CN)

(73) Assignees: Zhibin Huang, Foshan, Guangdong (CN); Zhigang He, Foshan, Guangdong (CN)

(21) Appl. No.: 13/825,967

(22) PCT Filed: Nov. 11, 2010
(86) PCT No.: PCT/CN2010/078628

§ 371 Date: Mar. 25, 2013

(30) Foreign Application Priority Data
Sep. 28, 2010 (CN) 201020547421.3

(51) Int. Cl. A47J 36/10

(52) U.S. Cl. CPC A47J 36/10
USPC 220/203.2; 220/203.01

(57) ABSTRACT

The present invention discloses a pressure cooker cover which comprises a cover (1) and a float valve (2), wherein a seal ring (7) is installed in the inner edge of the cover while hooks (8) are installed in the two side edges of the cover. A push-pull device (9) which can move the hooks back and forth is mounted in the ends of the hooks. The push-pull device comprises a rotating base (9-1) arranged in the middle portion of the cover, a rotating shaft (9-2) and a locking piece (9-3) which is coupled with the rotating shaft (9-2). Sliding chutes (9-31) are provided at the two sides of the locking piece. Guide columns (8-1) which are slidingly matched with the sliding chutes are set at two ends of the hooks (8).

### TECHNICAL FIELD

The invention relates to the technical field of pressure cooker, particularly to a pressure cooker cover.

### BACKGROUND ART

With the continuous improvement of people's living standard, pressure cooker gains increasing popularity among people for its convenient use, environmental protection and energy saving. In respect of the structure, it mainly comprises a shell, a cooker cover and a cooker body, wherein a float valve, a pressure relief valve and a safety valve are provided on the cooker cover; when the pressure in the cooker body rises to a certain level, the high pressure will prop up the float of the float valve to prevent the rotary opening of the cooker cover. It has a simple structure and is easy to use. The disadvantage of the structure is that the float can move up under external force whether the pressure in the cooker body is sufficient or whether the cooker cover is open, thus causing trouble to users.

### DISCLOSURE OF THE INVENTION

### Technical Problems

The purpose of the invention is to provide a pressure cooker cover featured by simple and reasonable structure, reliable safety performance and convenient use, so as to solve the existing technical deficiencies.

### Technical Solution

This invention adopts the following technical solution to achieve said purpose: A pressure cooker cover, comprising a cover and a float valve, wherein a seal ring is installed at the inner edge of the cover, characterized in that hooks are installed at the two side edges of the cover, and a push-pull device which can move the hooks back and forth is installed at the ends of the hooks.

Further more, said push-pull device comprises a rotating base installed in the middle portion of the cover, a rotating shaft and a locking piece coupled with the rotating shaft. Sliding chutes are provided on the two sides of the locking piece, and the sliding chutes slidably match the guide columns of the sliding bars respectively.

The end of said hooks extends inward to become a sliding bar, the two sliding bars of the hook are installed on the two sides of the rotating shaft respectively, a guiding chute is provided on the sliding bar and slidably matches the guide column installed correspondingly on the upper part of the cooker cover; the hooks are installed along the edge of the cooker cover, the end of the hooks is arc-shaped, and a supporting bar installed at the end of the sliding bar is connected to the hook.

The sliding chutes on the two sides of said locking piece are inclined, and an angle is formed between the sliding chute and the sliding bar at the end of the hook.

The side edge of said locking piece is provided with an opening, which allows the passing of the float of the float valve.

Said locking piece is Z-shaped, and the opening, which allows the passing of the float of the float valve, is installed at the horizontal end of the Z-shaped locking piece.

### Beneficial Effects

The invention adopting the said technical solution can achieve the following beneficial effects:

In this invention, hooks are installed at the two side edges of the cover, and a push-pull device which can move the hooks back and forth is installed at the ends of the hooks. When the rotating base is rotated, the hooks can be driven to move for engagement or disengagement of cooker cover; meanwhile, the upward or downward movement of the float enables locking or unlocking of the push-pull device, so as to ensure that the cooker cover can not be opened when there is pressure in the cooker and the users can use the cooker cover safely and conveniently.

### DESCRIPTION OF THE DRAWINGS

FIG. 1 is a schematic view of the unlocked cooker cover according to the invention;

FIG. 2 is a top view of FIG. 1;

FIG. 3 is a schematic view of the locked cooker cover according to the invention;

FIG. 4 is a top view of FIG. 3;

### DESCRIPTION OF NUMBER DESIGNATIONS IN THE ACCOMPANYING DRAWINGS

1. Cooker cover 1-1. Guide column of sliding bar 2. Float valve 3. Cooker body 4. Upper base 5. Insulation cover 6. Middle ring 7. Seal ring 8. Hook 8-1. Guide column of locking piece 8-2 Sliding bar 8-21. Guide chute 9. Push-pull device 9-1. Rotating base 9-2. Rotating shaft 9-3. Locking piece 9-31. Opening

### DETAILED DESCRIPTION OF THE PREFERRED EMBODIMENTS

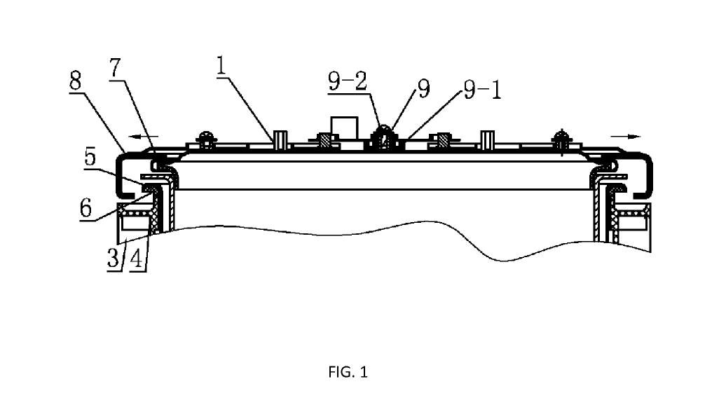

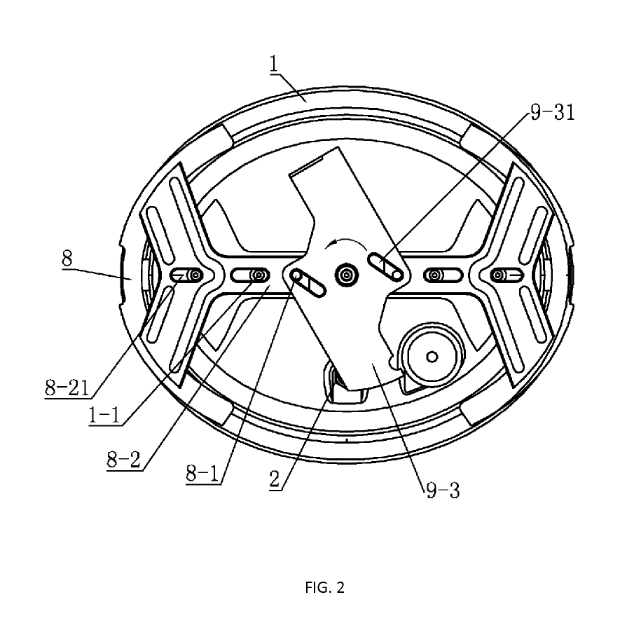

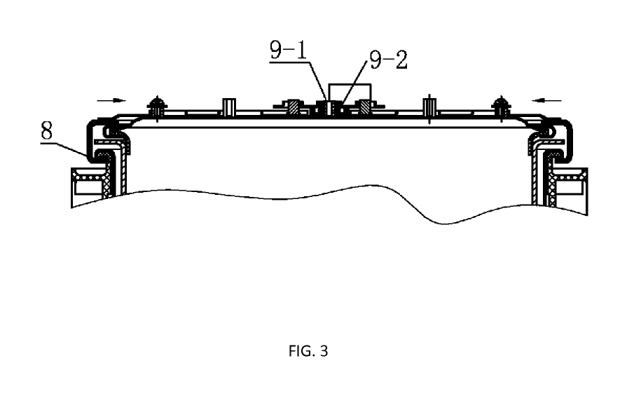

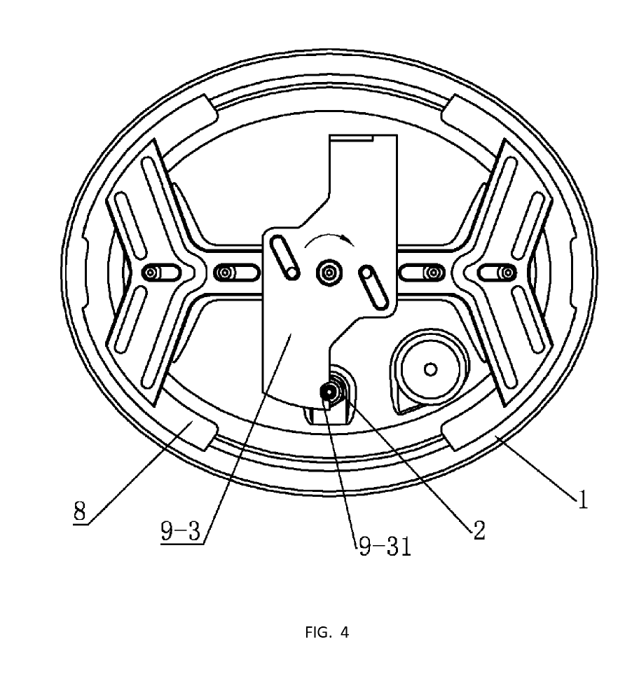

As illustrated in FIGS. 1-4, the invention discloses a pressure cooker cover, comprising a cover 1 and a float valve 2. The cover 1 matches the cooker body 3, an upper base 4 is provided on the upper part of the cooker body 3, an insulation cover 5 is provided in the cooker body 3, a flange is installed at the edge of the insulation cover 5, a middle ring 6 is embedded in the flange, a seal ring 7 is installed at the inner edge of the cover, which abuts against the inner wall of the inner container tightly, hooks 8 are installed at the two side edges of the cover, the hooks 8 match the insulation cover 5 and the middle ring 6, and a push-pull device 9 which can move the hooks back and forth is installed at the ends of the hooks 8. The push-pull device 9 comprises a rotating base 9-1 installed in the middle portion of the cover, a rotating shaft 9-2 and a locking piece 9-3 coupled with the rotating shaft. Sliding chutes 9-31 are provided at the two sides of the locking piece 9-3. The end of the hooks extends inward to become a sliding bar 8-2, a guide column of the locking piece 8-1 which slidably matches the sliding chute of the locking piece is provided at the end of the sliding bar, the sliding chute of the locking piece is inclined, and an angle is formed between the sliding chute of the locking piece and the guiding column of the locking piece installed at the end of the hook. The hooks are installed along the edge of the cooker cover, the end of the hooks is arc-shaped, and a supporting bar installed at the end of the sliding bar is connected to the hook. The two guide columns of the locking piece are installed at the two sides of the rotating shaft 9-2 respectively, a guide chute 8-21 is provided on the sliding bar 8-2, a guide column of sliding bar 1-1 corresponding to the guide chute is installed on the upper part of the cooker cover, and the side edge of the locking piece 9-3 is provided with an opening 9-31, which allows the passing of the float of the float valve. In this embodiment, the locking piece is Z-shaped, and the opening, which allows the passing of the float of the float valve, is installed at the horizontal end of the Z-shaped locking piece.

During use, rotate the rotating base clockwise, then the locking piece drives the guide columns of the locking piece on the hooks to move the hooks horizontally, so as to detach the hooks from the insulation cover and the middle ring and unlock the cooker cover; on the contrary, the cooker cover can be locked when the rotating base is rotated counterclockwise.

Said embodiment is only a preferred embodiment of this utility model, and it should be noted that certain modifications and improvements can be made by those of ordinary skill in the art without departing from the creative concept of this utility model, which also fall within the scope of protection of this utility model.

What is claimed is:

1. A pressure cooker cover, comprising a cover and a float valve, wherein a seal ring is installed at the inner edge of the cover, characterized in that hooks are installed at the two side edges of the cover, and a push-pull device which can move the hooks back and forth is installed at the ends of the hooks.

2. The pressure cooker cover of claim 1, characterized in that said push-pull device comprises a rotating base installed in the middle portion of the cover, a rotating shaft and a locking piece coupled with the rotating shaft, wherein sliding chutes are provided on the two sides of the locking piece, and guide columns which slidably match the sliding chutes are set at the ends of the hooks.

3. The pressure cooker cover of claim 2, characterized in that the end of said hooks extends inward to become a sliding bar, the two sliding bars of the hook are installed on the two sides of the rotating shaft respectively, a guiding chute is provided on the sliding bar, the guide column corresponding to the guide chute is provided on the upper part of the cooker cover.

4. The pressure cooker cover of claim 3, characterized in that said hooks are installed along the edge of the cooker cover, the end of the hooks is arc-shaped, and a supporting bar installed at the end of the sliding bar is connected to the hook.

5. The pressure cooker cover of claim 2, characterized in that the sliding chutes on the two sides of said locking piece are inclined, and an angle is formed between the sliding chute and the sliding bar at the end of the hook.

6. The pressure cooker cover of claim 2 or 3, characterized in that the side edge of said locking piece is provided with an opening, which allows the passing of the float of the float valve.

7. The pressure cooker cover of claim 6, characterized in that said locking piece is Z-shaped, and the opening, which allows the passing of the float of the float valve, is installed at the horizontal end of the Z-shaped locking piece.
